(19) United States
(12) Patent Application Publication
(10) Pub. No.: US 2003/0039857 A1
(43) Pub. Date: Feb. 27, 2003

(54) Nanoscale particles and the treatment of chlorinated contaminants

(76) Inventors: Wein-xian Zhang, Bethlehem, PA (US); Chuan-Bao Wang, Oakdale, PA (US); Hsing-Lung Lien, Ada, OK (US)

Correspondence Address: Competitive Techologies, Inc., 1960 Bronson Road, Fairfield, CT, 06430, US

(21) Appl. No.: 09/821,383

(22) Filed: Mar. 29, 2001

Related U.S. Application Data
(63) Continuation of application No. 09/283,045, filed on Apr. 1, 1999, now abandoned.
(60) Provisional application No. 60/080,373, filed on Apr. 1, 1998.

(51) Int. Cl. B32B 15/00; B32B 15/02

(52) U.S. Cl. 428/655; 428/570; 427/217; 423/240 S; 428/681; 428/670

(57) ABSTRACT

The present invention describes the utilization of nanoscale bimetallic particles for the treatment of chlorinated contaminants in the environment, and more specifically, chlorinated contaminants in groundwater.

### RELATED APPLICATION

This application claims priority from U.S. Provisional Patent Application No. 60/080,373, filed Apr. 1, 1998, and said Provisional Patent Application is incorporated herein by reference.

### FIELD OF THE INVENTION

The present invention relates generally to nanoscale particles and the utilization of such particles for the treatment of chlorinated contaminants in soils, sediments, aquifers and in industrial systems for water and waste treatment and more specifically to the treatment of tetrachloroethene, trichloroethene, dichloroethene, vinyl chloride, chlorinated methanes, chlorinated benzene and the like.

### BACKGROUND OF THE INVENTION

Synthetic organic compounds account for approximately one-third of the chemical production in the United States. Many such compounds are intentionally or inadvertently released into the environment. Increasing evidence indicates that the nation's ground water resource, which supplies over 50 percent of the drinking water, is threatened by contamination caused by past and present industrial, agricultural and commercial activities. Chlorinated solvents, such as tetrachloroethene (PCE), trichloroethene (TCE), dichloroethene (DCE), and vinyl chloride (VC), are among the most prevalent contaminants. Many of these compounds are known or potential threats to public health and the environment. Billions of dollars are being spent each year to decontaminate soils, sediments and groundwater aquifers in the U.S. The cost of the remediation of known sites in the U.S. is estimated well above one trillion dollars according to the current environmental standards and regulations.

Technologies using zero-valent metals is one of the methods used for treatment of halogenated organic compounds (HOCs). Laboratory research has demonstrated that metals can transform many HOCs such as chlorinated aliphatics, aromatics, and polychlorinated biphenyls. Currently, granular iron is usually applied in the “funnel and gate” treatment system, in which a porous wall of granular iron is constructed in the path of a contaminated groundwater plume. As contaminated water passes through the reactive barrier, HOCs react with the surface of iron to produce mostly benign compounds such as hydrocarbons, chloride, and water.

Many challenges still exist for implementation of the zero-valent metal technology such as:

(1) production and accumulation of chlorinated byproducts due to the low reactivity of iron powders towards lightly chlorinated hydrocarbons. For example, reduction of PCE and TCE by zero-valent iron has been observed to produce Cis-1-2,-DCE and VC. Both compounds are of considerable toxicological concern;

(2) decrease of iron reactivity over time, probably due to the formation of a surface passivation layer, or to the precipitation of metal hydroxides (Fe(OH)₂, Fe(OH)₃), and metal carbonates (FeCO₃) on the surface of iron;

(3) engineering difficulties in constructing iron walls in deep aquifers (e.g., >30 m), or regions inaccessible by the barrier structures; and

(4) the “funnel and gate” method is essentially a passive approach, i.e., a metal wall is built to contain the contamination and treatment begins only when the contaminant plume flows into the treatment wall.

Therefore, there is an urgent need to develop effective methods for treating chlorinated organic contaminants and a method for synthesizing nanoscale particles useful for such treatment.

### SUMMARY OF THE INVENTION

Applicant discloses a method of forming and utilizing zero-valent metals for degradation of HOCs and other contaminants. Nanoscale metal particles, with diameters in the range of 1 to 100 nm and which are characterized by high surface area to volume ratio, and high surface energies are used to accomplish effective treatment. Nanoscale metal particles, as used herein, means a metal particle having a diameter of between about 1-100 nanometers.

In a preferred embodiment, a bimetallic structure is adopted in which a thin layer of a catalyst (Pd) is doped on the surface of reductant (e.g., Fe, Zn). The presence of a catalyst reduces activation energy and increases the rate of dechlorination reactions, and more importantly, curtails production of chorinated byproducts.

Accordingly, it is an object of this invention to provide a method for synthesizing nanoscale particles for the treatment of chlorinated organic contaminants.

It is a further object of this invention to provide a method for expanding the surface area to volume ratios of such particles.

Yet another object of this invention is to provide a method for increasing the surface reactivity per unit of surface of nanoscale particles.

Another object of this invention is to reduce oxidation of iron reactivity by the use palladium film or other noble metal films on the particle surface.

A further object of this invention is to reduce production of toxic byproducts during chemical reduction of solvents.

Yet another object of this invention is to provide a method for directly injecting nanoscale particles into contaminated soils, sediments and aquifers for in situ remediation.

Further objects and advantages of the present invention will become apparent from a consideration of the drawings and ensuing description.

### BRIEF DESCRIPTION OF THE DRAWINGS

The foregoing aspects and further features and advantages of the invention will become more readily apparent from the following detailed description when taken in conjunction with the accompanying drawings in which:

FIG. 1 is a schematic of a nanoscale bimetallic particle for treatment of chlorinated solvents.

FIG. 2 is a chart showing the transformation of hexachlorobenzene over different bimetallic particles.

FIGS. 3(a-d) is a series of graphs showing transformation PCE, TCE, Cis-DCE and VC, respectively, by microscale Fe (Aldrich Fe), nanoscale Fe (Nano Fe), and nanoscale Pd/Fe particles (Nano Pd/Fe).

FIG. 4 shows reactions of TCE with nanoscale Fe particles (Fe), Pt-modified Fe (Pt/Fe), and Pd-modified Fe (Pd/Fe).

FIG. 5 shows reactions of trans-DCE with nanoscale Fe powders (Fe), Ni-modified Fe (Ni/Fe), and Pd-modified Fe (Pd/Fe).

FIGS. 6(a and b) shows transformation of a mixture of chlorinated aromatic compounds by nanoscale Pd/Fe, (a) relative GC peak areas at t=0, and (b) relative GC peak areas at t=24 hours.

### DETAILED DESCRIPTION

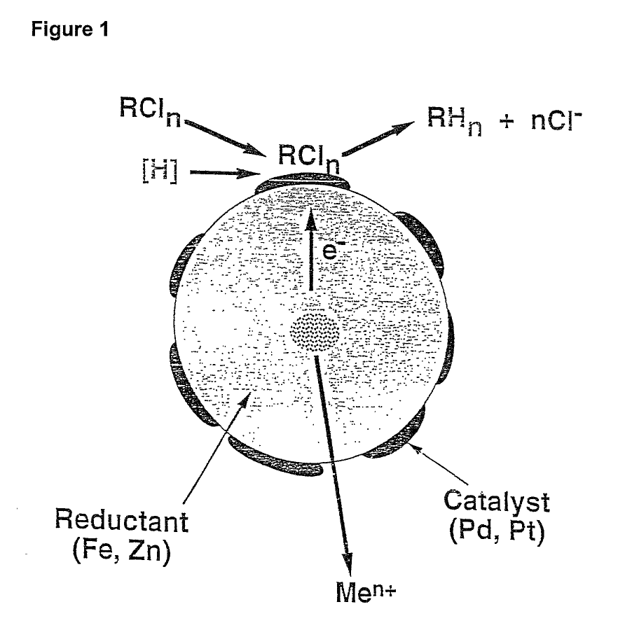

The present invention provides a method for treatment of chlorinated organic contaminants and synthesizing nanoscale particles useful for such treatment. Nanoscale Fe (Zn) particles (FIG. 1) were synthesized by adding 1.6 M NaBH₄ aqueous solution dropwise to a 1.0 M FeCl₃ (ZnCl₂) aqueous solution at ambient temperature with magnetic stirring. Ferric iron (Fe³⁺) was reduced and precipitated according to the following reaction:

Fe(H₂O)₆³⁺+3BH₄⁻+3H₂O→Fe↓+3B(OH)₃+10.5H₂

Particles with diameters in the range of 1-100 nm have high surface area to volume ratios, high-level stepped surface and high surface energy. Within a bimetallic complex, one metal (Fe, Zn) serves primarily as electron donor while the other (Pd, Pt) serves as catalyst.

Bimetallic complexes were then prepared by the method of reductive deposition. Ag⁺, Cu⁺, Co⁺, and Ni⁺ stock solutions were prepared by dissolving the corresponding metal salt into distilled water. The flasks containing the stock solutions were wrapped with aluminum foil and stored at room temperature. Pd²⁺ solution was freshly prepared each time before synthesis by dissolving predetermined amounts of palladium acetate in ethanol with the assistance of a sonar bath.

Bimetallic particles were made by directly adding the corresponding noble metal salt solution into a beaker containing freshly synthesized nano-Fe particles which caused the reduction and precipitation of noble metals on the Fe surface. The corresponding reaction can be expressed as follows:

2Mⁿ⁺+nFe→2M+nFe²⁺

The bimetal particles were then collected from the solution by vacuum filtration. The particles were washed thoroughly with distilled water.

In one embodiment hereof, the iron particles were coated with a thin layer of Pd by saturating the wet iron precipitates with an ethanol solution of [Pd(C₂H₃O₂)₂]₃, causing reduction and subsequent deposition of Pd on the Fe surfaces:

Pd²⁺+Fe⁰→Pd⁰↓+Fe²⁺

Similarly, Pd/Zn was prepared by saturating Zn powders with the ethanol solution of [Pd(C₂H₃O₂)₂]₃. It was observed that the color of Fe particles changed from black to reddish-brown within a few hours, indicating significant surface oxidation. Little observable color change was noticed on the dry Pd/Fe surfaces, suggesting Pd-modified Fe is stable in the air.

Characterization of the synthesized metal particles: BET surface areas of the nanoscale metal particles were measured using the nitrogen adsorption method at 77K with a Gemini 2360 surface analyzer. Prior to measurement, Fe and Pd/Fe samples were acid-washed and degassed at 250° C. with a flow of N₂. The particles were observed by a Phillips EM 400T transmission electron microscopy (TEM) at 120 kV to measure the size and size distribution. Crystal structure of the particles was examined with an APD 1700 automated powder diffractometer (XRD) with nickel-filtered CuKα radiation (λ=0.1542 nm). Analysis of TEM micrographs showed that most of the particles were in the range of 1-100 nm. Average BET surface area of the particles was 33.5 m²/g. In comparison, commercially available microscale Fe powders (<10 μm, Aldrich) have an average surface area to volume ratio of 0.9 m²/g as measured by the same method.

Batch experiments were conducted to test reactivity of the laboratory synthesized nanoscale particles for the dechlorination of several chlorinated pollutants (PCE, TCE, trans-DCE, VC, and several chlorinated aromatic compounds). In single compound experiments, 15 ml of 20 mg/L of PCE, TCE, trans-DCE, or VC aqueous solutions, and 1.0 g freshly prepared bimetallic powders were charged into a 50-ml vial with a Teflon mininert valve. The serum bottles were mixed on a platform shaker at ambient temperature (22±1° C.). Parallel experiments were conducted without metal particles (blank), or microscale Fe particles (>99.9%, <10 μm, Aldrich). For experiments with a 10-compound mixture of chlorinated compounds (2-chloronaphthalene, 1,2-dichlorobenzene, 1,3-dichlorobenzene, 1,4-dichlorobenzene, hexachlor-benzene, hexachlorobutadiene, hexachlorocyclo-pentadiene, hexachloro-ethane, 1,2,4,5-tetrachlorobenzene, and 1,2,4-trichlorobenzene), a stock solution of the organic mixture was combined with 0.1 g of metal powder in a 2 ml vial and agitated on a rotary shaker (30 rpm). Organic compounds in aqueous solutions were extracted with 0.5 ml pentane and analyzed by a Hewlett-Packard Model 5890 GC equipped with an electron capture detector (ECD) and a BD-624 capillary column (J & W Scientific). Detection limits were about 1.0-2.0 μg/L for chlorinated ethylenes and less than 1.0 μg/L for chlorinated benzenes. Hydrocarbon products in the headspace were identified with a GC-MS (HP 5970 GC MSD). Amounts of organic compounds volatilized into the headspace were corrected applying Henry's law. Production of chloride ion in solution was determined by ion chromatography (Dionex 120).

Batch experiments with PCBs: A 50 μL sample of 200 μg/mL Aroclor 1254 was combined with 0.1 g of the wet Fe or Pd/Fe particles and 2 mL ethanol/water solution (volume ratio=1:9), followed by mixing on a rotary shaker (30 rpm) for 17 hours. Analytical methods were similar to those described above for TCE experiments. 0.5 mL PCB solution were extracted by 0.5 mL pentane, and analyzed with GC-ECD. The following examples will serve to illustrate the present invention without being deemed limitative thereof.

### EXAMPLE 1

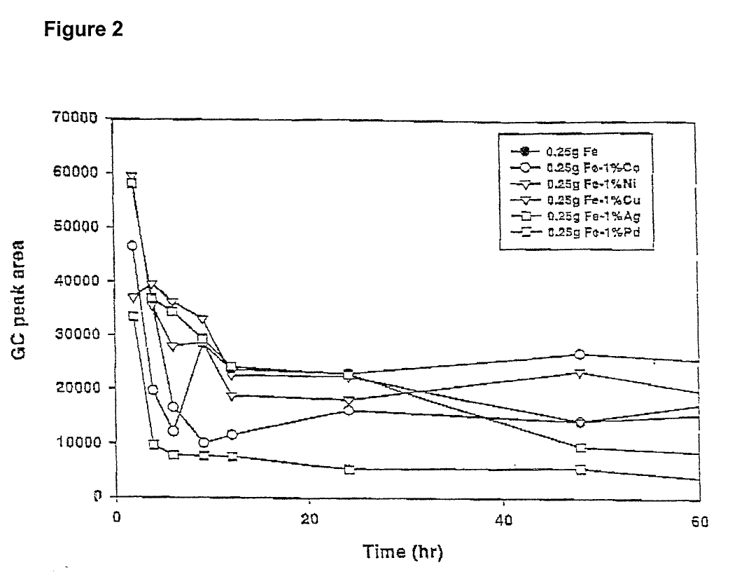

Transformation of hexachlorobenzene was achieved using nanoscale bimetallic complexes of bimetallic particles of cobaltized iron particles, nickelized iron particles, copperized iron particles, silverized iron particles, and palladized iron particles (FIG. 2). In all experiments, initial parent compound concentration of hexachlorobenzene was 2 ppm. Metal/bimetal particles to solution ratio was 0.25 g/100 ml. The amounts of organic compounds in both metallic (Fe) and bimetallic compounds remained relatively constant within about a period of 12-15 hours. The nanoscale pallidized iron particles showed the highest reactivity and efficacy in transformation of hexachlorobenzene.

### EXAMPLE 2

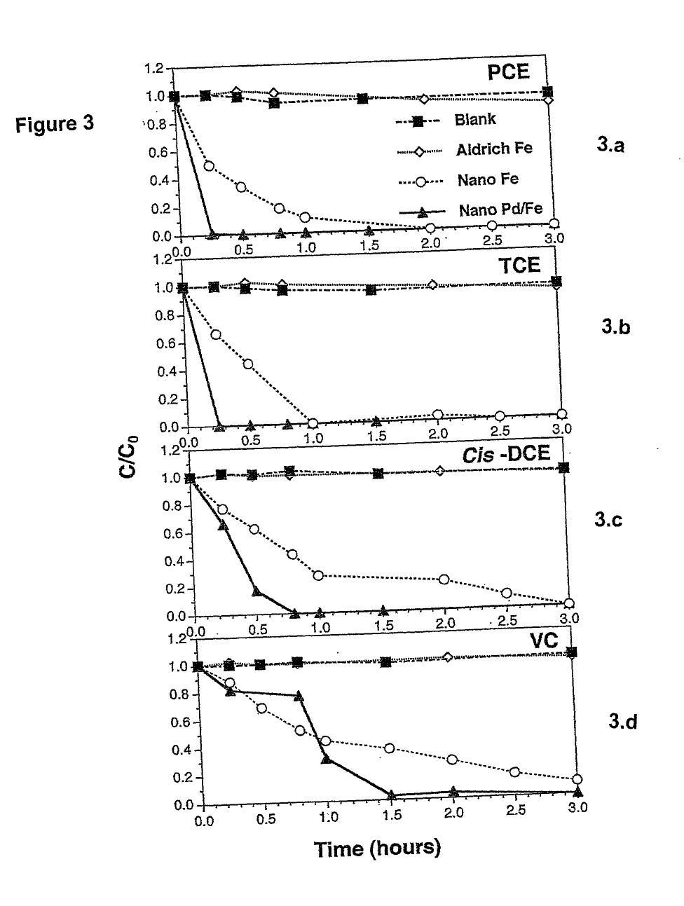

Rapid and complete dechlorination of PCE, TCE, DCE and VC was achieved by using the nanoscale iron and palladized iron particles as shown in (FIG. 3). In all experiments, initial organic concentration was 20 mg/L, and metal to solution ratio was 2 g/100 mL. The amounts of organic compounds in blank runs (without metal particles) and in the runs with microscale Fe particles (Aldrich Fe) remained relatively constant within a period of 3 hours, indicating insignificant leak and adsorption to glass wall of the serum bottles and slow reaction with the Aldrich iron. The palladized nanoscale Fe particles exhibited the highest reactivity. Both PCE and TCE were completely dechlorinated by the synthesized nano-Pd/Fe bimetallic particles within less than 0.25 hours. Cis-DCE was dechlorinated within 1 hour and VC within 1.5 hours, respectively. It took relatively longer to achieve complete dechlorination by using the nanoscale iron (between 2 to 3 hours). In runs using the nanoscale metal particles, no chlorinated byproducts (<5 μg/L) were detected in the solution. Final reaction products in the headspace were identified to be only hydrocarbons, including ethene, ethane, propene, propane, butene, butane, and pentane, Simultaneous increases in chloride concentrations were also observed in the aqueous solutions.

Evidence strongly suggests that, within a bimetallic system, one metal likely serves as catalyst (Pd, Pt, Ni) while the other as electron donor (Fe, Zn). Iron is a very effective reductant. The catalytic properties of Pd, Pt and Ni are different, likely due to their differences in surface atomic structures and their electron properties.

### EXAMPLE 3

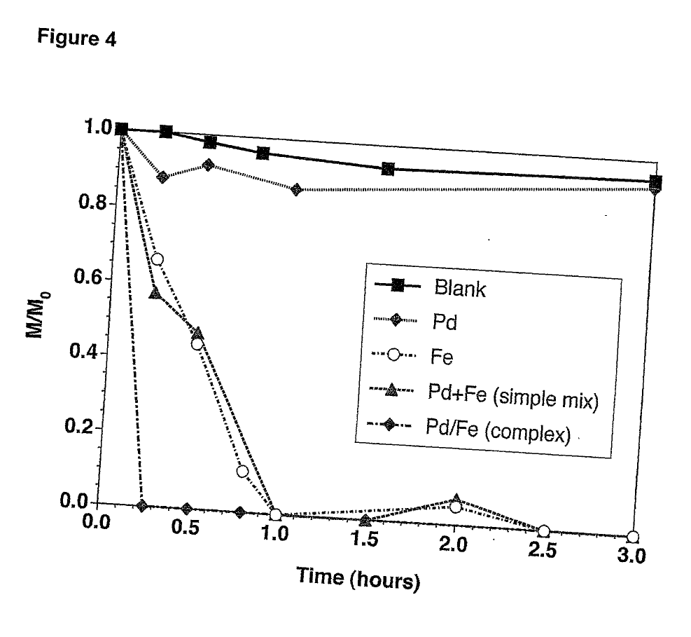

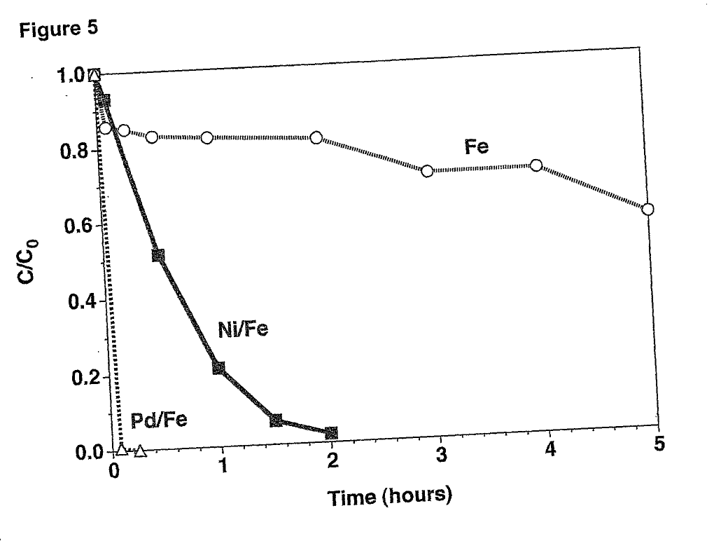

In another example, Pt, instead of Pd, was used as the catalyst. It is envisioned that any suitable catalyst could be utilized. FIG. 4 shows that in the presence of iron powders, 98% TCE was degraded within 60 minutes. In the presence of Pt/Fe, the same amount was reduced within 50 minutes. Initial organic concentration was 20 mg/ml. Metal solution ratio was 2 g/100 ml. In comparison, complete reduction of TCE was achieved within less than 20 minutes by the nanoscale Pd/Fe under similar conditions. Nickel was also observed to promote dechlorination of PCE, TCE, DCEs and VC. As shown in FIG. 5, nickelized iron (Ni/Fe) exhibited higher activity than the nanoscale iron for dechlorination of 9.7 mg/ml trans-DCE, but lower compared with the Pd/Fe particles. Initial organic concentration was 9.7 mg/L. Metal solution ratio was 10 g/100 ml.

### EXAMPLE 4

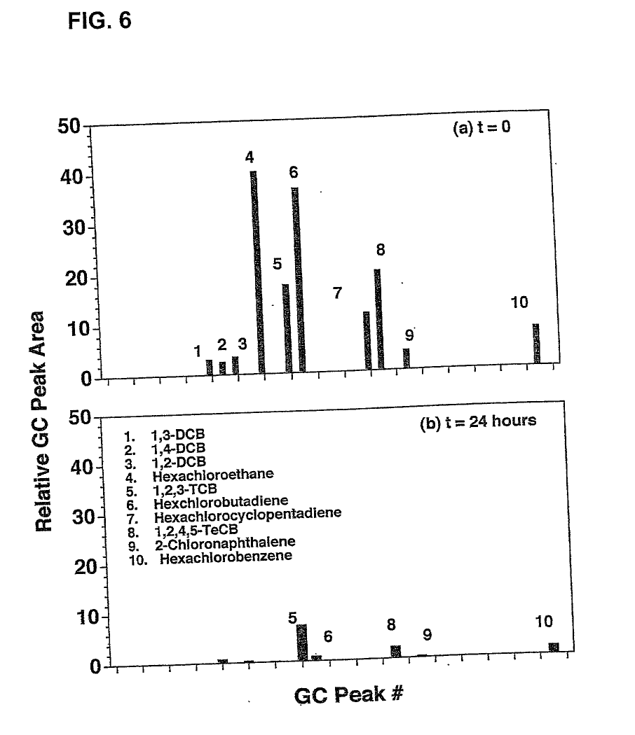

Experiments were also performed to test reactivity of the nanoscale metal particles for treatment of a mixture of chlorinated compounds. Metal to solution ratio was 5 g/100 ml (FIG. 6). An EPA chlorinated aromatic compound mixture solution containing 2-chloronaphthalene, 1,2-dichlorobenzene, 1,3-dichlorobenzene, 1,4-dichlorobenzene, hexachloro-benzene, hexachlorobutadiene, hexachlorocyclopentadiene, hexachloroethane, 1,2,4,5-tetrachlorobenzene, and 1,2,4-trichlorobenzene was used. Total initial organic concentration in the solution was about 10 mg/L at t=0 (FIG. 6a). As shown in FIG. 6b, about 90% of the chlorinated aromatic compound was reduced within 24 hours. Small amounts of chlorinated compounds (1,2,3-trichlorobenzene, 1,2,4,5-tetrachlorobenzene, hexachlorobenzene) remaining in the solution were completely (detention limits <10 μg) reduced within 48 hours. Similar results were also observed for dechlorination of PCB mixtures by using the nanoscale Pd/Fe particles.

### EXAMPLE 5

The nanoscale Fe particles have higher surface reactivity than microscale Fe particles (based on per unit surface area), and palladized Fe works even better. To compare the reaction rates observed under different experimental conditions, it is useful to consider the surface-area normalized reactivity of various metal particles. The rate of degradation of a chlorinated organic compound in a batch system can be described by the following equation:

$$\frac{ⅆ C}{ⅆ t} = - {k}_{SA} {a}_{s} {ρ}_{m} C$$

Where:

| | |
|---|---|
| C | concentration of organic compound in the aqueous phase (mg/L) |
| k_{SA} | surface-area-normalized rate coefficient (L/h/m²) |
| aₛ | specific surface area of metal (m²/g) |
| ρm | mass concentration of metal (g/L) |
| t | time (h) |

Here, k_{SA} is the specific reaction rate constant, a parameter for assessment of the overall surface reactivity. Table 1 gives the comparison of reactions of chlorinated ethylenes with the nanoscale bimetallic particles and k_{SA} values from literature. Surface-area normalized reactivity constants are up to 429 times higher than those of microscale iron particles.

TABLE 1

| _{Ksa}(L/h/m² | PCE | TCE | tDCE | cDCE | 1,1DCE |
|---|---|---|---|---|---|
| This study | 0.0122 | 0.0182 | 0.0151 | 0.0176 | 0.0115 |
| Literature data | (2.1 ± 2.7) × 10⁻³ | (3.9 ± 3.6) × 10⁻⁴ | (1.2 ± 0.4) × 10⁻⁴ | (4.1 ± 1.7) × 10⁻⁵ | (6.4 ± 5.5) × 10⁻⁵ |
| Ratio | 5.81 | 46.67 | 125.83 | 429.26 | 179.69 |

Overall performance of a nanoscale bimetallic complex for treatment of chlorinated organic pollutants is enhanced by: (1) expanding the surface area, (2) increasing the surface reactivity, and (3) curtailing production of byproducts. We believe the approaches outlined here offer opportunities for both fundamental research and technological applications of nanoscale particle technology in pollution control and environmental remediation.

What is claimed is:

1. A method of forming a nanoscale metallic particle, comprising the steps of:
a) providing a transition metal salt; and
b) contacting said transition metal salt with a reducing agent to form a metal particle with a diameter of between about 1 to 100 nanometers.

2. The method of claim 1, wherein said metal particle consists essentially of Fe³⁺or Zn²⁺.

3. The method of claim 2, wherein said reducing agent is sodium borohydride (NaBH₄).

4. A nanoscale metallic particle having a grain size of between about 1 to 100 nanometers, wherein said metallic particle has a surface area of between about 10 to 50 m²/g.

5. A method of forming a nanoscale integrated bimetallic particle, comprising the steps of:
a) providing nanoscale transition metal particles in a vessel; and
b) adding a noble metal salt solution to said nanoscale transition metal particles in the presence of a reductant to form metal particles with diameters of between about 1 to 100 nanometers.

6. A method of synthesizing a nanoscale integrated bimetallic as in claim 5, wherein said reductant is an ethanol solution of [X(C₂H₃O₂)₂]₃ wherein X is a noble metal.

7. A nanoscale integrated bimetallic particle, comprising:
a) an inner core containing a transition metal; and
b) an outer surface layer containing a noble metal, said outer surface layer having a surface area of between about 10 to 50 m²/g.

8. A nanoscale integrated bimetallic particle of claim 7, wherein said inner core consists essentially of Fe or Zn.

9. A nanoscale integrated bimetallic particle of claim 7, wherein said noble metal is selected from the group consisting essentially of Pd, Pt, Ni, Ag, Cu, and Co.

10. A nanoscale integrated bimetallic particle of claim 7, wherein said integrated bimetallic particle has a particle grain size diameter of between about 1 to 100 nm.

11. The nanoscale integrated bimetallic particle of claim 8, wherein the surface layer area normalized reactivity constant of Fe is between about 0.011˜0.018 L/h/m².

12. A method for treating chlorinated organic pollutants, comprising the steps of:
a) providing nanoscale integrated bimetallic particles; and
b) contacting chlorinated organic pollutants with said nanoscale integrated bimetallic particles.

13. A method for treating chlorinated organic pollutants as in claim 12, wherein said chlorinated organic pollutants are chlorinated organic solvents.

14. A method for treating chlorinated organic pollutants as in claim 13, wherein chlorinated organic solvents are from the group consisting essentially of tetrachloroethane (PCE), trichloroethene (TCE), dichloroethene (DCE), vinyl chloride (VC) tetrochlorinated methane (CT), trichloromethane and polychlorinated biphenyls (PCB's).

15. A method for treating chlorinated organic pollutants as in claim 12, wherein said pollutants are chlorinated aromatic compounds.

16. A method for treating chlorinated organic pollutants as in claim 12 further comprising:
a) providing a solid support;
b) immobilizing nanoscale integrated bimetallic particles onto said solid support; and
c) exposing said solid support to chlorinated organic pollutants for ex-situ treatment of contaminated waters and effluents.

17. A method for treating chlorinated organic pollutants as in claim 16 wherein said solid support is further comprised of activated carbon, zeolite or silica.
